(19) United States
(12) Patent Application Publication
(10) Pub. No.: US 2021/0097330 A1
(43) Pub. Date: Apr. 1, 2021

(54) NOTIFICATION CONTENT MESSAGE VIA ARTIFICIAL INTELLIGENCE VOICE RESPONSE SYSTEM

(71) Applicant: International Business Machines Corporation, Armonk, NY (US)

(72) Inventors: Robert Huntington Grant, Atlanta, GA (US); Zachary A. Silverstein, Jacksonville, FL (US); Shikhar Kwatra, Durham, NC (US); Sarbajit K. Rakshit, Kolkata (IN)

(21) Appl. No.: 16/585,221

(22) Filed: Sep. 27, 2019

(51) Int. Cl. G06K 9/62; G06N 5/02; G06N 20/00

(52) U.S. Cl. CPC G06K 9/626; G06K 9/6264; G06N 20/00; G06N 5/022

(57) ABSTRACT

Aspects of the present invention disclose a method to derive optimal notification content to be delivered to one or plurality of users based on congregating contextual information from interconnected devices. The method includes one or more processors identifying an interaction of a user with a computing device. The method further includes determining a first set of conditions of an operating environment that includes the interaction of the user with the computing device. The method further includes determining a relationship between the first set of conditions of the operating environment and the interaction of the user with the computing device. The method further includes generating a knowledge base that includes the determined relationship, the first set of conditions of the operating environment, and the interaction of the user with the computing device. The method further includes generating a notification message for the user based on the knowledge base.

### BACKGROUND OF THE INVENTION

The present invention relates generally to the field of mobile devices, and more particularly to generating notification content based on conditions.

In recent years, developments in digital assistants and the growth of Internet of Things (IoT) capable devices have created competition to introduce new voice interfaces (e.g., for smart speakers, virtual assistance hardware/software, etc.). The IoT is a network of physical devices embedded with electronics, software, sensors, and connectivity which enables these devices to connect and exchange data with computer-based systems. Technology is embedded in IoT-enabled devices that allow these devices to communicate, interact, be monitored, and controlled over the Internet.

Machine learning (ML) is the scientific study of algorithms and statistical models used to perform a specific task without using explicit instructions, relying on patterns and inference instead. Machine learning is seen as a subset of artificial intelligence. Machine learning algorithms build a mathematical model based on sample data, known as “training data”, in order to make predictions or decisions without being explicitly programmed to perform the task. Machine learning algorithms are used in a wide variety of applications.

Reinforcement learning (RL) is an area of machine learning concerned with how software agents ought to take actions in an environment so as to maximize some notion of cumulative reward. Reinforcement learning is one of three basic machine learning paradigms, alongside supervised learning and unsupervised learning. However, reinforcement learning differs from supervised learning in that labelled input/output pairs need not be presented, and sub-optimal actions need not be explicitly corrected. Instead the focus is finding a balance between exploration (of uncharted territory) and exploitation (of current knowledge).

### SUMMARY

Aspects of the present invention disclose a method, computer program product, and system to derive optimal notification content to be delivered to one or plurality of users based on congregating contextual information from interconnected devices. The method includes identifying, by one or more processors, an interaction of a user with a computing device. The method further includes determining, by one or more processors, a first set of conditions of an operating environment that includes the interaction of the user with the computing device. The method further includes determining, by one or more processors, a relationship between the first set of conditions of the operating environment and the interaction of the user with the computing device. The method further includes generating, by one or more processors, a knowledge base that includes the determined relationship, the first set of conditions of the operating environment, and the interaction of the user with the computing device. The method further includes generating, by one or more processors, a notification message for the user based at least in part on the knowledge base.

### BRIEF DESCRIPTION OF THE DRAWINGS

FIG. 1 is a functional block diagram of a data processing environment, in accordance with an embodiment of the present invention.

FIG. 2 is a flowchart depicting operational steps of a program, within the data processing environment of FIG. 1, for deriving an optimal notification content to be delivered to one or plurality of users based on congregating contextual information from interconnected devices, in accordance with embodiments of the present invention.

FIG. 3 is a block diagram of components of the client device and server of FIG. 1, in accordance with an embodiment of the present invention.

### DETAILED DESCRIPTION

Embodiments of the present invention allow for creation of a notification message based on environmental constraints. Embodiments of the present invention derive a context of a user interaction utilizing data of a plurality of internet of things (IoT) enabled devices. Embodiments of the present invention utilize reinforcement learning techniques to determine a relationship between a context of a user interaction and a notification message. Additional embodiments of the present invention utilize data characteristics and sub-sets of a plurality of internet of things (IoT) enabled devices to create hooks within a data set corpus.

Some embodiments of the present invention recognize that voice response systems have the capability of delivering voice-based alerts, notifications or even provide recommendations to a user. However, the voice response systems lack the ability to determine what types of notification message should be created based on environmental constraints. Various embodiments of the present invention solve this problem by utilizing one or more IoT enabled device to derive a context of a user interaction and creating a notification message to a user based on environmental constraints and historical interactions of the user.

Various embodiments of the present invention can operate to reduce the volume of input/output operations a server must process in order for a virtual assistant to perform a function. Embodiments of the present invention generates rules that may be stored on a client device locally to enable the virtual assistant perform functions without sending query data to the server. Thus, offloading a task initially performed by the server on to a local device, which increases processing resources of the server. Additionally, the present invention increases network resources of the server by reducing the amount of sensitive and/or personal data of the user that is transmitted to the server for processing.

Implementation of embodiments of the invention may take a variety of forms, and exemplary implementation details are discussed subsequently with reference to the Figures.

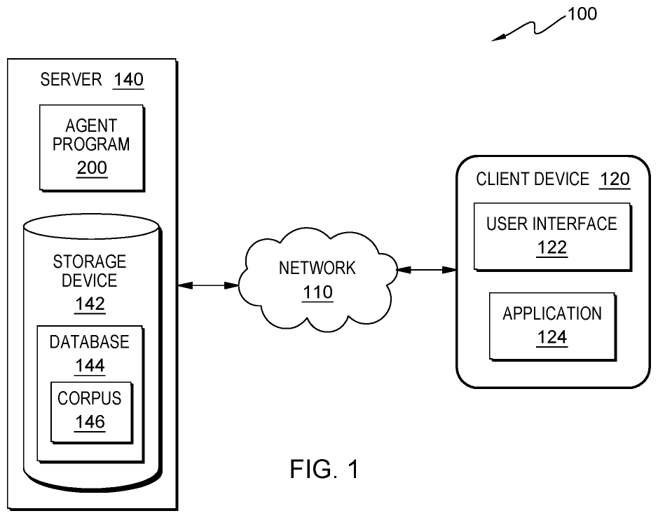

The present invention will now be described in detail with reference to the Figures. FIG. 1 is a functional block diagram illustrating a distributed data processing environment, generally designated 100, in accordance with one embodiment of the present invention. Figure 1 provides only an illustration of one implementation and does not imply any limitations with regard to the environments in which different embodiments may be implemented. Many modifications to the depicted environment may be made by those skilled in the art without departing from the scope of the invention as recited by the claims.

Various embodiments of the present invention can utilize accessible sources of personal data, which may include personal devices (e.g., client device 120), social media content, and/or publicly available information. For example, embodiments of the present invention can optionally include a privacy component that enables the user to opt-in or opt-out of exposing personal information. The privacy component can enable the authorized and secure handling of user information, such as tracking information, as well as personal information that may have been obtained, is maintained, and/or is accessible. The user can be provided with notice of the collection of portions of the personal information and the opportunity to opt-in or opt-out of the collection process. Consent can take several forms. Opt-in consent can impose on the user to take an affirmative action before the data is collected. Alternatively, opt-out consent can impose on the user to take an affirmative action to prevent the collection of data before that data is collected.

An embodiment of data processing environment 100 includes client device 120, and server 140, all interconnected over network 110. In one embodiment, client device 120 and server 140 communicate through network 110. Network 110 can be, for example, a local area network (LAN), a telecommunications network, a wide area network (WAN), such as the Internet, or any combination of the three, and include wired, wireless, or fiber optic connections. In general, network 110 can be any combination of connections and protocols, which will support communications between client device 120 and server 140, in accordance with embodiments of the present invention. In an example, a client device 120 sends a request to server 140 via the Internet (e.g., network 110) over which server 140 returns a response.

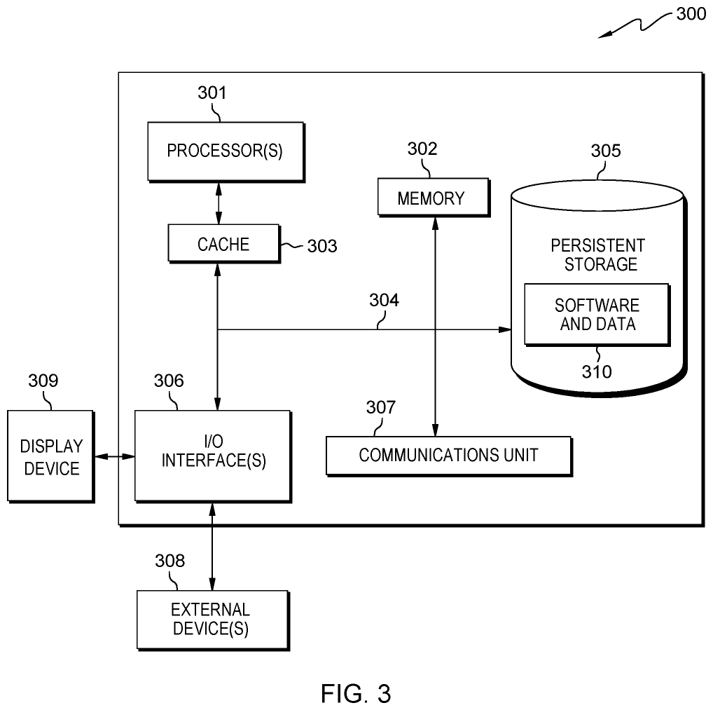

In various embodiments of the present invention, client device 120 may be a workstation, personal computer, digital video recorder (DVR), media player, personal digital assistant, mobile phone, or any other device capable of executing computer readable program instructions, in accordance with embodiments of the present invention. In general, client device 120 is representative of any electronic device or combination of electronic devices capable of executing computer readable program instructions. Client device 120 may include components as depicted and described in further detail with respect to FIG. 3, in accordance with embodiments of the present invention.

Client device 120 includes one or more speakers, a processor, a camera, user interface 122, and application 124. User interface 122 is a program that provides an interface between a user of client device 120 and a plurality of applications that reside on the client device. A user interface, such as user interface 122, refers to the information (such as graphic, text, and sound) that a program presents to a user, and the control sequences the user employs to control the program. A variety of types of user interfaces exist. In one embodiment, user interface 122 is a graphical user interface. A graphical user interface (GUI) is a type of user interface that allows users to interact with electronic devices, such as a computer keyboard and mouse, through graphical icons and visual indicators, such as secondary notation, as opposed to text-based interfaces, typed command labels, or text navigation. In computing, GUIs were introduced in reaction to the perceived steep learning curve of command-line interfaces which require commands to be typed on the keyboard. The actions in GUIs are often performed through direct manipulation of the graphical elements.

In another embodiment, user interface 122 is a script or application programming interface (API). In yet another embodiment, user interface 122 is a voice-user interface. A voice-user interface utilizes speech recognition methods to allow human interactions (e.g., spoken commands and questions) with computing systems. Voice command devices (e.g., home appliances, virtual assistants, smart phones, smart speakers, etc.) are typically controlled with a voice-user interface.

Application 124 is a computer program designed to run on client device 120. An application frequently serves to provide a user with similar services accessed on personal computers (e.g., web browser, playing music, or other media, etc.). In one embodiment, a user utilizes application 124 of client device 120 to access content. For example, application 124 is a web browser of a personal computer that a user can utilize to access sensor data of a plurality of IoT devices linked to a registered account of a user. In another embodiment, a user utilizes application 124 of client device 120 to register with agent program 200.

In various embodiments of the present invention, server 140 may be a desktop computer, a computer server, or any other computer systems, known in the art. In certain embodiments, server 140 represents computer systems utilizing clustered computers and components (e.g., database server computers, application server computers, etc.), which act as a single pool of seamless resources when accessed by elements of data processing environment 100. In general, server 140 is representative of any electronic device or combination of electronic devices capable of executing computer readable program instructions. Server 140 may include components as depicted and described in further detail with respect to FIG. 3, in accordance with embodiments of the present invention.

Server 140 includes storage device 142, database 144, corpus 146, and agent program 200. Storage device 142 can be implemented with any type of storage device, for example, persistent storage 305, which is capable of storing data that may be accessed and utilized by server 140 and client device 120, such as a database server, a hard disk drive, or a flash memory. In one embodiment storage device 142 can represent multiple storage devices within server 140. In various embodiments of the present invention storage device 142 stores a plurality of information, such as corpus 146 in database 144. Database 144 may represent one or more organized collections of data stored and accessed from server 140. In one embodiment, database 144 stores corpus 146 (e.g., knowledge base) that is utilized to train a machine learning algorithm and create a notification message for the user. For example, corpus 146 may include IoT sensor feeds, camera feeds, weather information, environment constraints, etc., corresponding to a user interaction with client device 120. In another embodiment, data processing environment 100 can include additional servers (not shown) that host additional information that accessible via network 110.

Generally, agent program 200 creates notification content that is delivered to one or a plurality of users utilizing reinforcement learning and congregating contextual information from plurality of interconnected devices. In one embodiment, agent program 200 utilizes a reinforcement learning algorithm to determine a context of an interaction between a user and client device 120. For example, agent program 200 captures usage statistics (e.g., statistics of commands of a user) and environmental statistics via integrations with IOT feeds, camera feeds, and environment data (e.g., audio levels, audio types, weather, people, etc.).

In another embodiment, agent program 200 determines a relationship between an interaction of a user and a context of the interaction with client device 120. For example, agent program 200 utilizes a machine learning model (e.g., Bi-directional long short-term memory (Bi-LSTM)) to detect patterns in the usage and environmental statistics (i.e., determines correlations between commands of a user to a smart speaker and the context (e.g., environmental statistics)). In yet another embodiment, agent program 200 creates a corpus of information corresponding to a determined relationship between an interaction of a user and a context of the interaction with client device 120. For example, agent program 200 utilizes determined relationships to derive and add rules to a knowledge base (e.g., corpus). In another example, agent program 200 uses data characteristics and sub-sets from the data feeds of IoT devices to create hooks within a knowledge base (e.g., corpus).

Agent program 200 identifies a set of conditions (e.g., a context) and performs a defined action based on a determined relationship. In an alternative embodiment, agent program 200 may operate locally on client device 120. For example, after agent program 200 builds an optimal knowledge base (e.g., corpus 146) of patterns or possible associations at the cloud-based server level, agent program 200 operate locally on client device 120 to detect environmental parameters and perform tasks associated with environmental parameters.

In one embodiment, agent program 200 utilizes corpus 146 to identify a context of an interaction of a user and client device 120. For example, agent program 200 utilizes an IoT application of a smart speaker (e.g., client device 120) to receive data feeds of IoT enabled devices, cameras, environment data (e.g., weather applications), microphones etc., to determine a context preceding and subsequent to a user utilizing a voice interface of the smart speaker. In this example, agent program 200 detects loud bass sound (e.g., environmental parameter, music, sound waves, etc.) originating from an apartment of a downstairs neighbor in an apartment of the user. Further, agent program 200 identifies a reaction (e.g., commands virtual agent to play thunder white noise) of the user to the loud bass sound and utilizes natural language processing (NLP) to capture the user stating that the bass is loud.

Additionally, agent utilization program 300 adds a context (e.g., environmental parameter), reaction (e.g., voice command), and importance level (e.g., captured audio phrase) to a knowledge base. Furthermore, agent program 200 utilizes machine learning techniques (e.g., iterative machine learning, reinforcement learning (RL), etc.) to update data of the knowledge base (e.g., corpus 146) to determine a relationship between an environmental parameter and an interaction of the user. Generally, an environmental parameter includes one or more indicators that provides information about and/or describes the state of the environment (e.g., an operating environment of client device 120), and has a significance extending beyond that directly associated with any given condition of the environment. An environmental parameter may encompass indicators of environmental conditions and responses.

In another embodiment, agent program 200 provides a notification message to a user based on an identified context and corpus 146. For example, agent program 200 utilizes natural language understanding (NLU) and natural language generation (NLG) to create a notification message to provide to a user. In this example, agent program 200 utilizes NLG to generate a voice message to play over the speaker of a smart speaker (e.g., client device 120) to prompt a user to confirm playing thunder white noise. In yet another embodiment, agent program 200 determines whether an identified context and provided notification message comply with preferences of a user. For example, agent program 200 detects loud bass sounds (e.g., environmental parameter) and utilizes a knowledge base to determine whether a reaction of a user (e.g., stored in corpus 146) corresponds to the loud bass. Alternatively, agent program 200 can generate a question using NLG techniques to confirm that the loud bass is related to the reaction (e.g., voice command) before performing a defined action (e.g., playing thunder white noise).

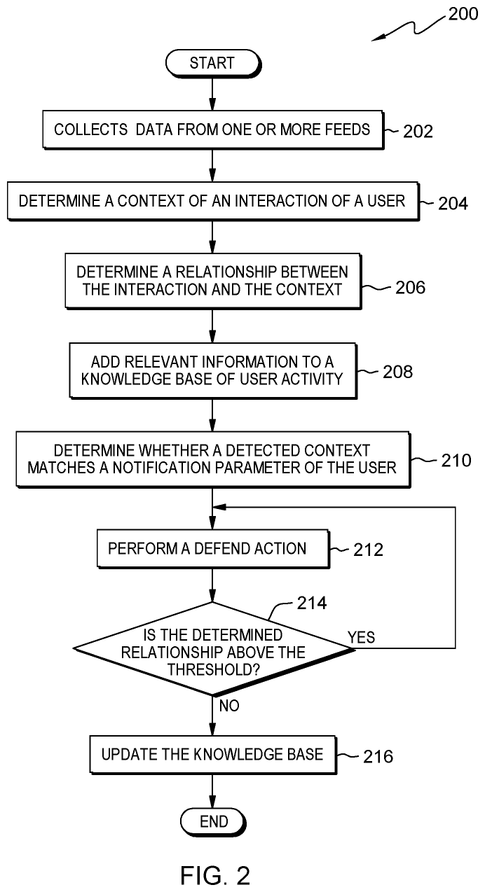

FIG. 2 is a flowchart depicting operational steps of agent program 200, a program to derive optimal notification content to be delivered to one or plurality of users based on congregating contextual information from interconnected devices, in accordance with embodiments of the present invention. In one embodiment, agent program 200 initiates in response to client device 120 receiving a voice command from a user. For example, agent program 200 initiates when a smart speaker (e.g., client device 120) receives a voice instruction corresponding to a task to play audio. In another embodiment, agent program 200 is continuously monitoring client device 120. For example, agent program 200 is constantly monitoring activities of a smart speaker (e.g., client device 120) after a user registers the smart speaker with a server that includes agent program 200.

In step 202, agent program 200 collects data of one or more feeds. In one embodiment, agent program 200 identifies an interaction of a user with client device 120. For example, agent program 200 monitors a voice interface (e.g., user interface 122) of a smart speaker (e.g., client device 120) to detect a command of a user. In this example, agent program 200 determines that the command the smart speaker receives corresponds to a task to play audio (e.g., thunder white noise). In another example, agent program 200 monitors a graphical user interface (e.g., user interface 122) of a laptop to detect an interaction of a user. In this example, agent program 200 determines that the command the laptop receives corresponds to deleting an email from an application after receiving a notification.

In another embodiment, agent program 200 retrieves data of IoT devices and client device 120 via network 110. For example, agent program 200 uses the Internet to retrieve IoT device feeds, camera feeds, and weather information from an application of a smart speaker. In this example, the application can be a software application linked to an account of a server that includes a plurality of registered IoT devices. Additionally, agent program 200 can utilize devices (e.g., cameras, microphones, speakers, etc.) of the smart speaker to collect data from the operating environment of the smart speaker. In another example, agent program 200 retrieves data in response to determining that a smart speaker receives a voice command.

In step 204, agent program 200 determines a context of an interaction of the user. In one embodiment, agent program 200 utilizes data of application 124 to determine a context of an interaction of a user and client device 120. For example, agent program 200 continuously monitors a smart speaker for receipt of a command. Additionally, agent program 200 retrieves data of applications (e.g., weather applications), cameras, and IoT devices linked to an account of a user on a server (e.g., server 140) to determine a context (i.e., a set of conditions) of the command. In this example, agent program 200 can utilize the data to determine the identity of people present, information associated with an identified person, commands, and type of interaction with the smart speaker, etc. Furthermore, agent program 200 stores the retrieved data in a database of a server (e.g., server 140).

In an example embodiment, a user is sitting in a room of an apartment where client device 120, a camera, and an IoT device are also located. In this example, agent program 200 is utilizing client device 120, the camera, and the IoT device to collect data about an environment surrounding the user. For example, agent program 200 uses data of the camera to identify the user and to determine that the user is alone in the room. Also, agent program 200 utilizes textual data of a laptop (e.g., IoT device) to determine that the user is currently performing a work-related task. Additionally, agent program 200 detects audio (e.g., loud bass from music) in the environment surrounding the user and collects the command received by client device 120 from the user subsequent to detecting the audio. Furthermore, agent program 200 stores the derived conditions (e.g., the context) of the environment corresponding to the command received by client device 120 in database 144.

In various embodiments of the present invention, agent program 200 utilizes reinforcement learning, which may refer to an area of machine learning concerned with how an agent ought to take actions in an environment so as to maximize some notion of reward (e.g., immediate or cumulative). Additionally, reinforcement learning includes goal-oriented learning via interactions between a learning agent (e.g., agent program 200) and the environment (i.e., the user and client device 120). At each point in time, the learning agent performs an action, and the environment generates an observation and an instantaneous cost, according to some (usually unknown) dynamics. The aim of the reinforcement learning is often to discover a policy (e.g., rule, relationship, etc.) for selecting actions (e.g., notification messages, generated questions, etc.) that minimizes some measure of a long-term cost (i.e., the expected cumulative cost). Positive reinforcement is defined as when an event, occurs due to a particular behavior, increases the strength and the frequency of the behavior. However, negative reinforcement is defined as strengthening of a behavior because a negative condition is stopped or avoided.

In step 206, agent program 200 determines a relationship between the interaction and the context. In one embodiment, agent program 200 determines a relationship between a context and an interaction of a user with client device 120. For example, agent program 200 inputs conditions of the environment (e.g., context) of a smart speaker into a deep reinforcement learning model as an initial state from which the deep reinforcement learning model will initiate. In this example, there are many possible outputs due to a variety of solutions to a problem (i.e., actions of a user in response to the context). Additionally, agent program 200 utilizes the deep reinforcement learning model to determine the relationship based upon the inputs, where the deep reinforcement learning model will output a state. Accordingly, based on an action of the user the deep reinforcement learning model rewards or punishes the determined relationship based on the output of the deep reinforcement learning model. Furthermore, the deep reinforcement learning model continues to learn until the best solution is decided based on the maximum reward, which agent program 200 utilizes as the determined relationship.

In an example embodiment, agent program 200 increments a reward function of a deep reinforcement learning model when a user provides to client device 120 a satisfactory response with respect to the context derived from an operating environment of client device 120. In this example, the reward function can be increment by +1 in case of a satisfactory response with a feedback that is fed back in the state function of the deep reinforcement learning model every time a notification content message is created and provided to the user. Additionally, commands and/or responses of a user that includes words that affirm actions of agent program 200 (e.g., thanks, great, etc.) can be used to increment the reward function.

In another example, agent program 200 utilizes a covariance method (e.g., Pearson correlation) to determine whether an interaction (e.g., voice command) with a smart speaker (e.g., client device 120) is correlated with an environmental parameter (e.g., context, set of conditions, etc.). In this example, agent program 200 can utilize a machine learning algorithm to select or decide which set or subset of IoT devices to aggregate and derive one or more environmental parameters. Additionally, agent program 200 can also to generate inquires to the user to derive additional inputs. In one scenario, if agent program 200 identifies a new set of conditions (i.e., IoT device feeds, camera feeds, weather information, surrounding context, etc.), then agent program 200 generates questions for the user to determine a relationship between a context and an interaction of a user with client device 120. In another embodiment, agent program 200 generates questions about a context to assist in determining a relationship between the context and an interaction of a user with client device 120. For example, agent program 200 identifies a set of conditions (e.g., context, environmental parameter, etc.) and utilizes NLP and NLG to generate predefined questions corresponding to one or more conditions of the set of conditions.

In another embodiment, agent program 200 utilizes a machine learning algorithm to generate questions about a context to assist in determining a relationship between the context and an interaction of a user with client device 120. For example, agent program 200 can utilize a Bi-LSTM model (e.g., bidirectional long-short term memory, bidirectional recurrent neural network, etc.) to generate questions for an identified condition of the context (e.g., environmental parameter). In this example, agent program 200 trains the Bi-LSTM model using historical answers of a user to pre-defined questions for a data source (e.g., IoT device feeds, camera feeds, weather information, surrounding context, etc.) to determine the types of questions agent program 200 should generated with respect to the data source. Additionally, agent program 200 utilizes the generated questions to determine a correlation between the interaction of the user with a smart speaker (e.g., client device 120) and the context (e.g., set of identified conditions, environmental parameters, etc.).

In another embodiment, agent program 200 utilizes a machine learning algorithm to identify a defined time period to deliver questions to a user via client device 120. For example, agent program 200 can utilize a Bi-LSTM model to identify an appropriate time frame to transmit a question to a user through a smart speaker using data of IoT device feeds or camera feeds. In this example, agent program 200 can use data of the camera to identify that the user is present and use the data of IoT devices to identify that the user is not currently engaged in any activity with an IoT device. Additionally, agent program 200 determines whether the user is available to receive a question.

In yet another embodiment, agent program 200 utilizes a machine learning algorithm and NLP to determine a relationship between a context and an interaction of a user with client device 120 based on a response of a user. Additionally, agent program 200 determines which types of questions to generate in response to a user interacting with client device 120 based on a context and historical responses of the user. For example, agent program 200 uses NLG to generate pre-defined questions (e.g., relevance, required action, impact or criticality, expected, etc.) for a user to determine which conditions of the context (e.g., set of conditions) is important with respect to an interaction of the user with a smart speaker (e.g., client device 120). In this example, agent program 200 uses NLP techniques (e.g., natural language understanding (NLU)) to process verbal responses of the user to a question of the smart speaker, which is input into a Bi-LSTM-RNN model. Further, in this example, agent program 200 utilizes the Bi-LSTM-RNN model to determine applicable notification types and follow up questions based on the identified combination of conditions of the context and responses of the user. Additionally, agent program 200 uses the Bi-LSTM-RNN model to utilize historical data (e.g., past responses, past interactions, past contexts, etc.) to identify the types of questions that should be provided as well as the type of message that should be constructed for a notification.

In an example embodiment, agent program 200 provides questions to the user based on the detecting loud bass (e.g., audio) while the user is performing a work-related task to determine the importance of an environmental parameter of the context. In this example embodiment, based on detecting the audio and performance of a work-related task in the environment, agent program 200 may ask the following questions: how does the context effect the user; what action is required with respect to the effect on the user; what is the impact or criticality of the identified combination of environmental parameters of the context; and whether the identified combination of environmental parameters of the context is expected to the user or not etc. Additionally, agent program 200 uses NLU to process the responses and determine that the loud bass is an important environmental parameter, and that the user prefers to play audio (e.g., white noise) in response to detecting loud bass (i.e., agent program 200 correlates a current context with a desired action. Furthermore, agent program 200 can identify notification types that are effective or preferred by the user based on an identified environmental parameter of the context.

In step 208, agent program 200 adds relevant information to a corpus. In one embodiment, agent program 200 stores captured data corresponding to a determined relationship of an interaction of a user with client device 120 and a context in storage device 142. For example, agent program 200 stores relevant information (e.g., identities, commands, interaction type, weather conditions, user responses, environmental parameters, etc.) of the determined relationship in a database of a server (e.g., server 140). In an example embodiment, agent program 200 captures audio data of a user stating, “This bass is so loud!” and stores the statement, current context (e.g., work-related tasks, environmental parameter of loud bass, etc.), user reaction, and importance level based on the statement of the user to the corpus 146.

In step 210, agent program 200 determines whether a detected context matches a notification parameter of the user. In one embodiment, agent program 200 utilizes data of corpus 146 to determine whether a context of an operating environment of client device 120 are present. For example, agent program 200 monitors data feeds of IoT devices, a camera, and a smart speaker to determine whether an environmental parameter (e.g., context) previously stored in a knowledge base (e.g., corpus) is present in the operating environment of the smart speaker.

In one scenario, if agent program 200 monitors an operating environment of a smart speaker (e.g., client device 120) and detects environmental parameter of loud bass that is not derived from a user (e.g., context of corpus 146), then agent program 200 performs a defined action (as discussed in step 212). In another scenario, if agent program 200 monitors an operating environment of a smart speaker (e.g., client device 120) and detects environmental parameter of loud bass that is derived from a user and the user is not performing a work related task (e.g., not context of corpus 146), then agent program 200 can return to step 206 and monitor actions of a user to determine a relationship between the context and the user interaction.

In step 212, agent program 200 performs a defined action. In one embodiment, agent program 200 utilizes corpus 146 to perform a defined action that corresponds to an interaction of a user with client device 120. For example, a defined action is an action that agent program 200 performs that corresponds to a context of a knowledge base (e.g., corpus 146). In this example, agent program 200 may perform a previously performed action of a user to one or more context of the knowledge base. Furthermore, agent program 200 may provide a confirmation request to the user prior to performing the previously performed action of the user. In another embodiment, in response to agent program 200 determining that a current context does not exist in corpus 146, agent program 200 performs a defined action.

In an example embodiment, agent program 200 detects the environmental parameter of bass and agent program 200 provides a smart speaker with instructions to ask a user, “Do you want to turn on the Thunder white noise?”. In an alternative example embodiment, if agent program 200 determines an environmental parameter is not within the knowledge base, then agent program 200 may provide a smart speaker with instructions to ask a user, “Is the thunder white noise related to the bass environmental parameter?”.

In decision step 214, agent program 200 determines whether the determined relationship is above a threshold. In one embodiment, agent program 200 utilize corpus 146 to determine whether a determined relationship of a user interaction with client device 120 and a context is above a defined threshold. For example, agent program 200 monitors an environment of a smart speaker and detects a determined relationship (i.e., a pattern of behavior of a user interacting with client device 120) of a knowledge base (e.g., corpus 146) a number of occurrences over a defined time period. In this example, the determined relationship is not matured (i.e., having reached an advanced stage of development a characteristic of a determined relationship) until the number of occurrences of the determined relationship is detected is greater than a defined threshold of a user preference.

In an example embodiment, agent program 200 utilizes corpus 146 via a machine learning algorithm and detects a relationship between environmental parameter of loud bass that is not being played by a user (i.e., the context) and an interaction of the user (e.g., giving client device 120 a command to “turn on thunder white noise”). Additionally, agent program 200 utilizes the number of occurrences of the context and the interaction of the user is detected to determine whether the relationship is mature (e.g., an optimal solution is identified).

If agent program 200 determines that a determined relationship of a user interaction with client device 120 and a context is above a defined threshold (decision step 214, “YES” branch), then agent program 200 performs a defined action (discussed in step 212). In one scenario, if agent program 200 determines that a number of occurrences of a determined relationship is detected is greater than a defined threshold, then agent program 200 performs a defined action that corresponds to a context of a knowledge base (e.g., corpus 146). In an example embodiment, in response to agent program 200 determining that a determined relationship of a user interaction with client device 120 and a context of an operating environment of client device 120 is optimal, then agent program 200 may become proactive when the determined relationship is detected and can prompt and ask a user, “Do you want to turn on the thunder white noise?” or asking the user, “Is the thunder white noise related to the bass environmental parameter?”.

If agent program 200 determines that a determined relationship of a user interaction with client device 120 and a context is less than or equal to a defined threshold (decision step 214, “NO” branch), then agent program 200 utilizes a machine learning algorithm to update corpus 146 (discussed below in step 216). In one scenario, if agent program 200 determines that a number of occurrences of a determined relationship is detected is less than or equal to a defined threshold, then agent program 200 updates a knowledge base (e.g., corpus 146) based on an action of a user.

In step 216, agent program 200 updates the knowledge base. In one embodiment, agent program 200 modifies corpus 146 based on interactions of a user with client device 120. For example, if agent program 200 detects a negative connotation and/or response from a user via a smart speaker (e.g., client device 120), then agent program 200 inputs the negative connotation and/or response into a deep reinforcement learning model to reduce the reward function. In this example, agent program 200 utilizes the deep reinforcement learning model to determine a different relationship or a different combination of conditions of the context based on preferences and/or actions of the user. Additionally, agent program 200 updates data (e.g., determined relationships, context, interactions, etc.) of a knowledge base (e.g., corpus 146).

FIG. 3 depicts a block diagram of components of client device 120 and server 140, in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

FIG. 3 includes processor(s) 301, cache 303, memory 302, persistent storage 305, communications unit 307, input/output (I/O) interface(s) 306, and communications fabric 304. Communications fabric 304 provides communications between cache 303, memory 302, persistent storage 305, communications unit 307, and input/output (I/O) interface(s) 306. Communications fabric 304 can be implemented with any architecture designed for passing data and/or control information between processors (such as microprocessors, communications and network processors, etc.), system memory, peripheral devices, and any other hardware components within a system. For example, communications fabric 304 can be implemented with one or more buses or a crossbar switch.

Memory 302 and persistent storage 305 are computer readable storage media. In this embodiment, memory 302 includes random access memory (RAM). In general, memory 302 can include any suitable volatile or non-volatile computer readable storage media. Cache 303 is a fast memory that enhances the performance of processor(s) 301 by holding recently accessed data, and data near recently accessed data, from memory 302.

Program instructions and data (e.g., software and data 310) used to practice embodiments of the present invention may be stored in persistent storage 305 and in memory 302 for execution by one or more of the respective processor(s) 301 via cache 303. In an embodiment, persistent storage 305 includes a magnetic hard disk drive. Alternatively, or in addition to a magnetic hard disk drive, persistent storage 305 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305. Software and data 310 can be stored in persistent storage 305 for access and/or execution by one or more of the respective processor(s) 301 via cache 303. With respect to client device 120, software and data 310 includes data of user interface 122 and application 124. With respect to server 140, software and data 310 includes data of database 144, corpus 146, and agent program 200.

Communications unit 307, in these examples, provides for communications with other data processing systems or devices. In these examples, communications unit 307 includes one or more network interface cards. Communications unit 307 may provide communications through the use of either or both physical and wireless communications links. Program instructions and data (e.g., software and data 310) used to practice embodiments of the present invention may be downloaded to persistent storage 305 through communications unit 307.

I/O interface(s) 306 allows for input and output of data with other devices that may be connected to each computer system. For example, I/O interface(s) 306 may provide a connection to external device(s) 308, such as a keyboard, a keypad, a touch screen, and/or some other suitable input device. External device(s) 308 can also include portable computer readable storage media, such as, for example, thumb drives, portable optical or magnetic disks, and memory cards. Program instructions and data (e.g., software and data 310) used to practice embodiments of the present invention can be stored on such portable computer readable storage media and can be loaded onto persistent storage 305 via I/O interface(s) 306. I/O interface(s) 306 also connect to display 309.

Display 309 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method comprising:
identifying, by one or more processors, an interaction of a user with a computing device;
determining, by one or more processors, a first set of conditions of an operating environment that includes the interaction of the user with the computing device;
determining, by one or more processors, a relationship between the first set of conditions of the operating environment and the interaction of the user with the computing device;
generating, by one or more processors, a knowledge base that includes the determined relationship, the first set of conditions of the operating environment, and the interaction of the user with the computing device; and
generating, by one or more processors, a notification message for the user based at least in part on the knowledge base.

2. The method of claim 1, further comprising:
identifying, by one or more processors, a second set of conditions in the operating environment that includes the interaction of the user with the computing device;
determining, by one or more processors, that the second set of conditions in the operating environment matches the determined first set of conditions of the operating environment included in the knowledge base; and
performing, by one or more processors, a defined action based at least in part on the user interaction of the knowledge base.

3. The method of claim 1, further comprising:
determining, by one or more processors, whether a count of a number of occurrences of the determined relationship exceeds a defined threshold of occurrences over a defined timeframe; and
in response to determining that the count of the number of occurrences of the determined relationship exceeds the defined threshold of occurrences, over the defined timeframe, modifying, by one or more processors, the knowledge base based on the number of detected occurrences of the determined relationship.

4. The method of claim 2, further comprising:
detecting, by one or more processors, a reaction of the user to performing the defined action, wherein the reaction of the user is selected from a group consisting of: affirmative actions and negation actions; and
updating, by one or more processors, a reward function of a reinforced learning model of the knowledge base based on the reaction of the user.

5. The method of claim 1, wherein determining the first set of conditions of the operating environment that includes the interaction of the user with the computing device, further comprises:
collecting, by one or more processors, data corresponding to the operating environment of the computing device from one or more interconnected devices; and
aggregating, by one or more processors, the collected data that includes conditions of the operating environment, wherein the collected data corresponds to a defined time period that includes events prior to and subsequent the user interaction with the computing device.

6. The method of claim 1, wherein determining the relationship between the first set of conditions of the operating environment and the interaction of the user with the computing device, further comprises:
inputting, by one or more processors, the first set of conditions of the operating environment for the interaction of the user with the computing device into a reinforcement learning model; and
selecting, by one or more processors, an output state of the reinforcement learning model, wherein the output state includes a determined relationship with a maximum reward value.

7. The method of claim 2, wherein performing the defined action based at least in part on the user interaction of the knowledge base, further comprises:
identifying, by one or more processors, an action of the user in the knowledge base, wherein the action corresponds to a determined relationship between the first set of conditions of the operating environment and the interaction of the user with the computing device; and
performing, by one or more processors, the identified action, wherein performance of the identified action is selected from a group consisting of: previously performed actions of a user and providing a performance confirmation request.

8. The method of 1, wherein the determined relationship includes an influence of the first set of conditions on the user that is correlated to inducing an interaction between the user and the computing device.

9. A computer program product comprising:
one or more computer readable storage media and program instructions stored on the one or more computer readable storage media, the program instructions comprising:
program instructions to identify an interaction of a user with a computing device;
program instructions to determine a first set of conditions of an operating environment that includes the interaction of the user with the computing device;
program instructions to determine a relationship between the first set of conditions of the operating environment and the interaction of the user with the computing device;
program instructions to generate a knowledge base that includes the determined relationship, the first set of conditions of the operating environment, and the interaction of the user with the computing device; and
program instructions to generate a notification message for the user based at least in part on the knowledge base.

10. The computer program product of claim 9, further comprising program instructions, stored on the one or more computer readable storage media, to:
identify a second set of conditions in the operating environment that includes the interaction of the user with the computing device;
determine that the second set of conditions in the operating environment matches the determined first set of conditions of the operating environment included in the knowledge base; and
perform a defined action based at least in part on the user interaction of the knowledge base.

11. The computer program product of claim 9, further comprising program instructions, stored on the one or more computer readable storage media, to:
determine whether a count of a number of occurrences of the determined relationship exceeds a defined threshold of occurrences over a defined timeframe; and
in response to determining that the count of the number of occurrences of the determined relationship exceeds the defined threshold of occurrences, over the defined timeframe, modify the knowledge base based on the number of detected occurrences of the determined relationship.

12. The computer program product of claim 10, further comprising program instructions, stored on the one or more computer readable storage media, to:
detect a reaction of the user to performing the defined action, wherein the reaction of the user is selected from a group consisting of: affirmative actions and negation actions; and
update a reward function of a reinforced learning model of the knowledge base based on the reaction of the user.

13. The computer program product of claim 9, wherein program instructions to determine the first set of conditions of the operating environment that includes the interaction of the user with the computing device, further comprise program instructions to:
collect data corresponding to the operating environment of the computing device from one or more interconnected devices; and
aggregate the collected data that includes conditions of the operating environment, wherein the collected data corresponds to a defined time period that includes events prior to and subsequent the user interaction with the computing device.

14. The computer program product of claim 9, wherein program instructions to determine the relationship between the first set of conditions of the operating environment and the interaction of the user with the computing device, further comprise program instructions to:
input the first set of conditions of the operating environment for the interaction of the user with the computing device into a reinforcement learning model; and
select an output state of the reinforcement learning model, wherein the output state includes a determined relationship with a maximum reward value.

15. The computer program product of claim 10, wherein program instructions to perform the defined action based at least in part on the user interaction of the knowledge base, further comprise program instructions to:
identify an action of the user in the knowledge base, wherein the action corresponds to a determined relationship between the first set of conditions of the operating environment and the interaction of the user with the computing device; and
perform the identified action, wherein performance of the identified action is selected from a group consisting of: previously performed actions of a user and providing a performance confirmation request.

16. The computer program product of claim 9, wherein the determined relationship includes an influence of the first set of conditions on the user that is correlated to inducing an interaction between the user and the computing device.

17. A computer system comprising:
one or more computer processors;
one or more computer readable storage media; and
program instructions stored on the computer readable storage media for execution by at least one of the one or more processors, the program instructions comprising:
program instructions to identify an interaction of a user with a computing device;
program instructions to determine a first set of conditions of an operating environment that includes the interaction of the user with the computing device;
program instructions to determine a relationship between the first set of conditions of the operating environment and the interaction of the user with the computing device;
program instructions to generate a knowledge base that includes the determined relationship, the first set of conditions of the operating environment, and the interaction of the user with the computing device; and
program instructions to generate a notification message for the user based at least in part on the knowledge base.

18. The computer system of claim 17, further comprising program instructions, stored on the one or more computer readable storage media for execution by at least one of the one or more processors, to:
identify a second set of conditions in the operating environment that includes the interaction of the user with the computing device;
determine that the second set of conditions in the operating environment matches the determined first set of conditions of the operating environment included in the knowledge base; and
perform a defined action based at least in part on the user interaction of the knowledge base.

19. The computer system of claim 17, further comprising program instructions, stored on the one or more computer readable storage media for execution by at least one of the one or more processors, to:
determine whether a count of a number of occurrences of the determined relationship exceeds a defined threshold of occurrences over a defined timeframe; and
in response to determining that the count of the number of occurrences of the determined relationship exceeds the defined threshold of occurrences, over the defined timeframe, modify the knowledge base based on the number of detected occurrences of the determined relationship.

20. The computer system of claim 18, further comprising program instructions, stored on the one or more computer readable storage media for execution by at least one of the one or more processors, to:
detect a reaction of the user to performing the defined action, wherein the reaction of the user is selected from a group consisting of: affirmative actions and negation actions; and
update a reward function of a reinforced learning model of the knowledge base based on the reaction of the user.
